(19) United States
(12) Patent Application Publication
(10) Pub. No.: US 2015/0106761 A1
(43) Pub. Date: Apr. 16, 2015

(54) INFORMATION PROCESSING APPARATUS, METHOD FOR CONTROLLING THE INFORMATION PROCESSING APPARATUS, AND STORAGE MEDIUM

(71) Applicant: CANON KABUSHIKI KAISHA, Tokyo (JP)

(72) Inventor: Ikufumi Moriya, Funabashi-shi (JP)

(21) Appl. No.: 14/399,882

(22) PCT Filed: Mar. 29, 2013
(86) PCT No.: PCT/JP2013/002169

§ 371 Date: Nov. 7, 2014

(30) Foreign Application Priority Data
May 9, 2012 (JP) 2012-107877

(51) Int. Cl. G06F 3/0485; G06F 3/0481; G06T 3/20; G06F 3/0484

(52) U.S. Cl. CPC G06F 3/0485; G06F 3/04845; G06F 3/0481; G06T 3/20
USPC 715/784

(57) ABSTRACT

An information processing apparatus capable of displaying in a display area a partial range of a map image as a display range includes an object display means for displaying an object on the map image, an operation means for receiving an instruction corresponding to a user operation, and a display control means for moving, if an instruction for moving the display range of the map image is received by the operation means, the map image to an instructed direction to display thereof, wherein the instruction for moving the display range of the map image includes directional information, and wherein if the instruction for moving the display range of the map image received by the operation means satisfies a first condition, the display control means performs control to move the display range until an object is displayed, and then stop moving the display range.

### TECHNICAL FIELD

The present invention relates to an information processing apparatus for controlling map display.

### BACKGROUND ART

With the popularization of the global positioning system (GPS) in recent years, location information is appended to an image. Accordingly, the imaging location of an image is displayed on a map. For example, Japanese Patent Application Laid-Open No. 2010-182008 discusses a technique for displaying the imaging location of an image on a map. With such map display, a user can scroll the map image to move the display range. However, if the imaging location of a target image is distant from the current display range, time and effort are required to repetitively move the display range to find the target image.

### CITATION LIST

### Patent Literature

PTL 1: Japanese Patent Application Laid-Open No. 2010-182008

### SUMMARY OF INVENTION

The present invention is directed to reducing the process of user operations for searching for a target image.

According to an aspect of the present invention, an information processing apparatus capable of displaying in a display area a partial range of a map image as a display range includes an object display means for displaying an object associated with location information at a location corresponding to the location information on the map image in the display area, an operation means for receiving an instruction corresponding to a user operation, and a display control means for moving, if an instruction for moving the display range of the map image is received by the operation means, the map image to an instructed direction to display thereof, wherein the instruction for moving the display range of the map image includes directional information, and wherein if the instruction for moving the display range of the map image received by the operation means satisfies a first condition, the display control means performs control to move the display range until an object not displayed in the display area during receiving the instruction is displayed, and then stop moving the display range.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus according to a first exemplary embodiment.

FIG. 2 schematically illustrates a management table according to the first exemplary embodiment.

FIG. 3A illustrates example of display screens according to the first exemplary embodiment.

FIG. 3B illustrates example of display screens according to the first exemplary embodiment.

FIG. 3C illustrates example of display screens according to the first exemplary embodiment.

FIG. 4 illustrates a positional relationship of a display range according to the first exemplary embodiment.

FIG. 5 is a flowchart illustrating an operation of the information processing apparatus according to the first exemplary embodiment.

FIG. 6 illustrates a search range according to the first exemplary embodiment.

FIG. 7 schematically illustrates a management table according to a second exemplary embodiment.

FIG. 8 illustrates a positional relationship of a display range according to the second exemplary embodiment.

FIG. 9 is a flowchart illustrating an operation of an information processing apparatus according to the second exemplary embodiment.

FIG. 10 illustrates an example of a display screen according to the second exemplary embodiment.

FIG. 11 illustrates an example of a screen for setting a search condition according to the second exemplary embodiment.

FIG. 12A, which composes FIG. 12, is a flowchart illustrating an operation of an information processing apparatus according to a third exemplary embodiment.

FIG. 12B, which composes FIG. 12, is a flowchart illustrating an operation of an information processing apparatus according to a third exemplary embodiment.

FIG. 13 illustrates an example of a screen for setting a condition according to the third exemplary embodiment.

FIG. 14 illustrates an example of a screen for setting a start condition according to the third exemplary embodiment.

### DESCRIPTION OF EMBODIMENTS

Various exemplary embodiments, features, and aspects of the invention will be described in detail below with reference to the drawings.

The following exemplary embodiments are to be considered as illustrative examples for achieving the present invention, and may be corrected, and modified as required depending on the configuration of an apparatus according to the present invention and other various conditions. Further, each exemplary embodiment may be arbitrarily combined.

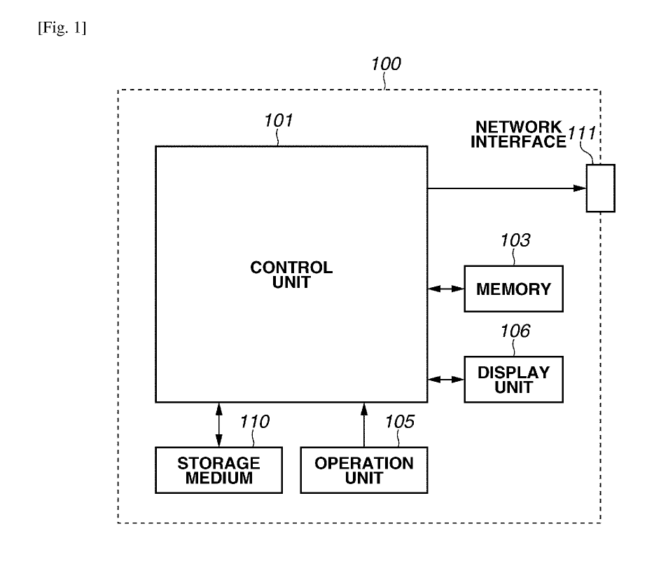

A first exemplary embodiment will be described below. FIG. 1 illustrates a configuration of an information processing apparatus according to the present exemplary embodiment. The information processing apparatus according to the present exemplary embodiment is, for example, a personal computer, a mobile phone, a digital camera, and a tablet device.

A control unit 101 controls each unit of an information processing apparatus 100 based on an input signal and a program (described below). Instead of being controlled by the control unit 101, the entire information processing apparatus may be controlled by a plurality of hardware components sharing processings.

A memory 103 is used as a buffer memory for temporarily storing data, an image display memory for a display unit 106, and a work area for the control unit 101.

An operation unit 105 receives an instruction to the information processing apparatus 100 from the user. The operation unit 105 includes a keyboard and a pointing device, such as a mouse, a touchpad, and a touch panel. In the present exemplary embodiment, a touch panel capable of detecting contact to the display unit 106 is included in the operation unit 105. The control unit 101 detects at intervals of unit time the coordinates of a contact point on the touch panel at which a finger or pen touches. Thus, the following operations made on the touch panel can be detected.

An action to touch the touch panel with the finger or pen (hereinafter referred to as “touch-down”). A state where the finger or pen is in contact with the touch panel (hereinafter referred to as “touch-on”). An action to move the finger or pen held in contact with the touch panel (hereinafter referred to as “move”). An action to detach the finger or pen from the touch panel (hereinafter referred to as “touch-up”). A state where the finger or pen is not in contact with the touch panel (hereinafter referred to as “touch-off”).

For move, the moving direction of the finger or pen moving on the touch panel can be determined for each of the vertical and horizontal components on the touch panel based on change in the coordinates of the contact point. If the control unit 101 detects a move operation equal to or longer than a predetermined distance from the coordinates of the touch-down position, the control unit 101 determines that a drag operation has been performed. If the control unit 101 detects a move operation at a speed equal to or faster than a predetermined speed from the touch-down position and subsequently detects a touch-up operation, the control unit 101 determines that a flick operation has been made. Generally, a flick is an operation in which the user quickly moves the finger held in contact with the touch panel equal to or longer than a predetermined distance and subsequently detach the finger therefrom, in other words, the user quickly trace in such a way as to flip the surface of the touch panel with the finger.

The predetermined distance is set to such a value that the movement of the coordinates of the contact point can be almost ignored. This value is used to prevent the movement of the coordinates due to an unintended finger wobble from being detected as a flick or drag operation. Therefore, for example, the predetermined distance is preliminarily set to a value larger than the moving distance of the coordinates due to an unintended finger wobble. A touch-down operation at a plurality of positions (generally referred to as multi-touch) can be detected. The above-described operations can be detected for the coordinates of each point of a multi-touch operation.

The display unit 106 displays data stored in the information processing apparatus 100 and data supplied thereto. For example, the display unit 106 displays a display area drawn in a window of an information management application program (described below). The information processing apparatus 100 may not necessarily include the display unit 106 as long as the information processing apparatus 100 can be connected with the display unit 106 and is provided with at least a display control function for controlling display of the display unit 106.

A storage medium 110 stores various control programs executed by the control unit 101, an operating system (OS), contents information (image and audio files), the information management application program, and map images. As the map images, an image is prepared for each fixed scale interval. An image with a smaller scale stores more detailed information. In the present exemplary embodiment, image files are handled as an Exchangeable Image File Format-Joint Photographic Experts Group (EXIF-JPEG) image file. With the EXIF-JPEG image file format, a thumbnail and attribute information can be stored in the header of a file.

The storage medium 110 may be a different component from the information processing apparatus 100 or included in the information processing apparatus 100. In other words, it is only necessary that the information processing apparatus 100 has a means for accessing the recording medium 110.

A network interface 111 is used to connect to a network circuit, such as the Internet. Although, in the present exemplary embodiment, image files and map images are stored in the storage medium 110, the present invention is similarly applicable to a case where image files and map images are obtained from an external device via the network interface 111.

In this case, for example, the network interface 111 accesses an external device via communication conforming to the Hypertext Transfer Protocol (HTTP). The information processing apparatus 100 according to the present exemplary embodiment may be achieved by a single information processing apparatus or an as-needed plurality of information processing apparatuses having distributed each function. If the information processing apparatus 100 is configured with a plurality of information processing apparatuses, these apparatuses are connected, for example, via a local area network (LAN) to enable communication therebetween. The information processing apparatus 100 may further include an imaging unit (including a lens, a shutter, etc.) for forming a subject's image and generating image data. Specifically, image files may be data captured by the information processing apparatus 100.

The following describes the above-described information management application program (hereinafter referred to as information management application). The following operation of the information management application is implemented when the control unit 101 reads the information management application and OS from the storage medium 110 and performs control according to the information management application. The information management application according to the present exemplary embodiment is provided with a map display mode in which the imaging location of an image file stored in the storage medium 110 is superimposed on the map image. In the present exemplary embodiment, location information and date information are stored in the header area of an image file. The location information indicates the imaging location and the date information indicates the imaging date. In the map display mode, the control unit 101 suitably performs display by referring to these pieces of information.

In the present exemplary embodiment, the information management application manages only image files specified to be managed by the information management application according to a user instruction out of image files recorded on the recording medium 110. By selecting a menu of the information management application, the user can select image files to be managed by the information management application out of image files stored in the recording medium 110. The image files determined to be managed by the information management application according to a user instruction are registered to a management table stored in the information management application.

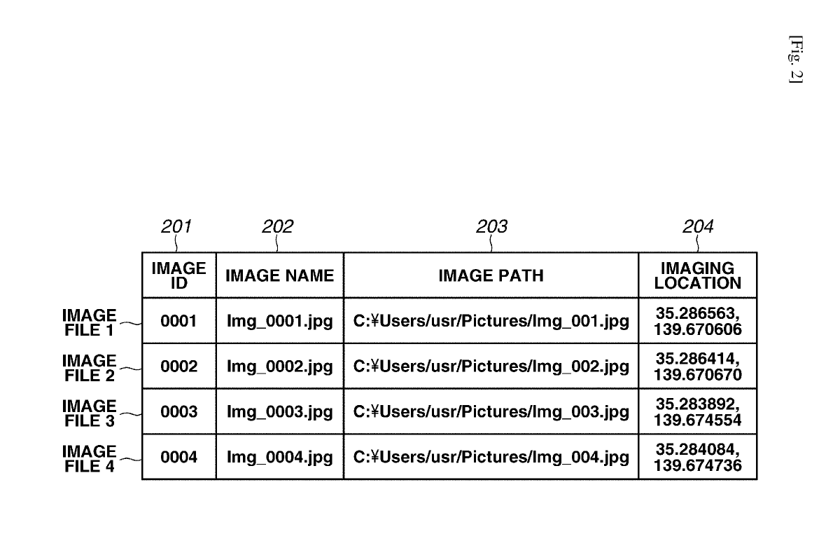

FIG. 2 schematically illustrates the management table for managing various data for each of image files stored in the recording medium 110. In the management table, an image identifier (ID) 201 is used to identify each image file. The information management application distinguishes and manages each image file based on the image ID 201. An image name 202 indicates the name of each image file. An image path 203 indicates which area on the storage medium 110 the image file is stored in. The information management application refers to the image path 203 to access the image file. An imaging location 204 is location information indicating the imaging location of each image file. In the present exemplary embodiment, location information is recorded as the latitude and longitude. Based on the latitude and longitude, the information management application can display on the map a pin indicating the imaging location of an image file.

The following describes the overview of map display by the information management application. The information management application can display on the map a pin indicating the imaging location of an image file by referring to the management table.

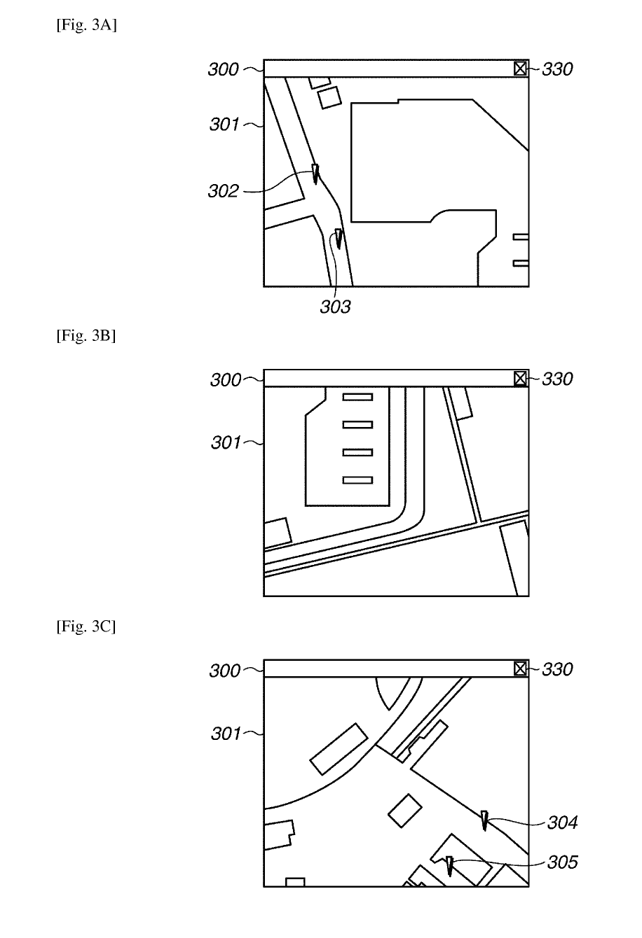

FIG. 3A illustrates an example of a map display screen displayed referring to the management table illustrated in FIG. 2. Referring to FIG. 3A, the map image is displayed in the display area 301 of a window 300. Further, a pin 302 indicating the imaging location of an image file 1 and a pin 303 indicating the imaging location of an image file 2 are displayed superimposed with the map image. Pins corresponding to image files 3 and 4 are not displayed since the imaging locations thereof are not included in the display range.

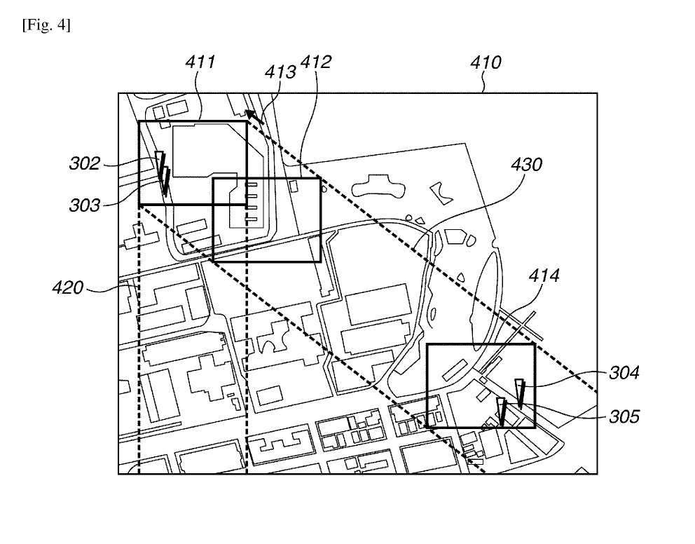

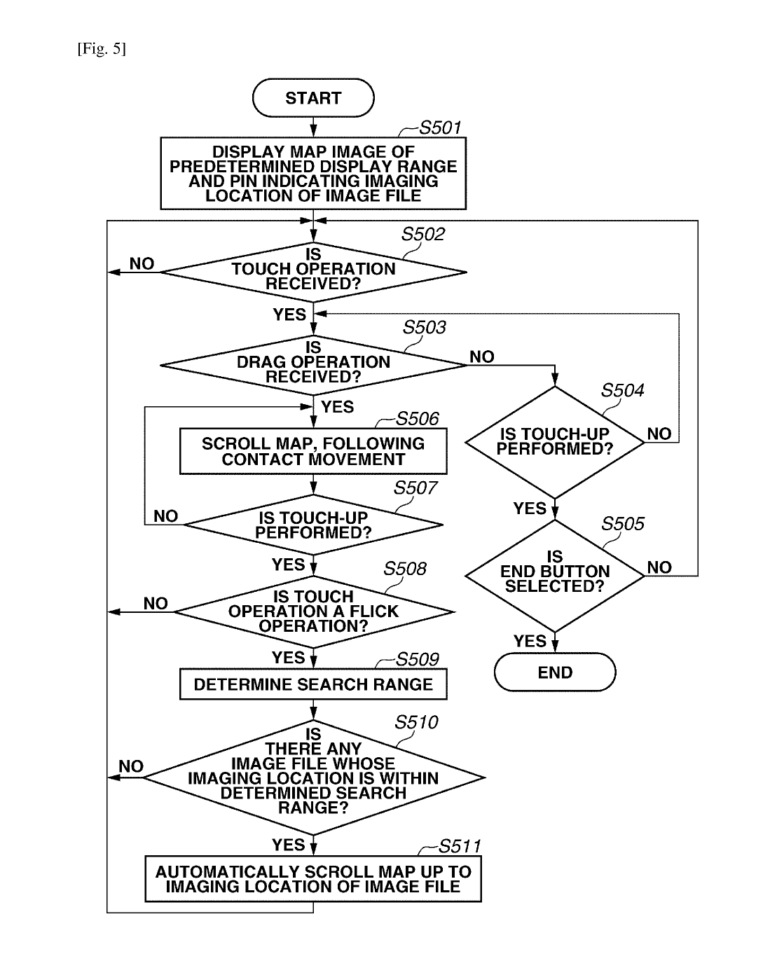

FIG. 4 illustrates a relationship between the display range on the map image displayed in the display area 301 illustrated in FIG. 3A and the imaging locations of the image files 3 and 4. FIG. 4 illustrates a portion clipped from the map for description. The display range on the map image displayed in the display area 301 illustrated in FIG. 3A corresponds to a range 411 illustrated in FIG. 4. Referring to FIG. 4, pins 304 and 305 indicate the imaging locations of the image files 3 and 4, respectively. If the screen as illustrated in FIG. 3A is displayed, the user can display a map image corresponding to any desired display range.

For example, by performing a drag operation by using the touch panel included in the operation unit 105, the user can scroll the map image in the direction of the drag operation (hereinafter referred to as drag direction). In other words, the display range can be moved in a direction opposite to the drag direction.

For example, if the user performs a drag operation in the upper-left direction of the display area 301 (a direction 413 illustrated in FIG. 4) on the screen illustrated in FIG. 3A, the user can input an instruction for moving the display range in the lower-right direction (in a direction opposite to the direction 413 illustrated in FIG. 4). If the user inputs this instruction, the map image and the pins scroll in the drag direction in response to the drag operation. In other words, the display range is moved in the lower-right direction (in a direction opposite to the direction 413 illustrated in FIG. 4) from the range 411.

As a result, for example, a screen as illustrated in FIG. 3B is displayed. The display range on the map image displayed in the display area 301 illustrated in FIG. 3B corresponds to the range 412 illustrated in FIG. 4. The display range illustrated in FIG. 3B does not include the imaging locations of the image files 1 to 4 in the management table. Therefore, no pin is displayed on the map image in the display area 301 illustrated in FIG. 3B.

Since a drag operation is an operation made on the screen, only a limited range can be newly displayed with one drag operation. In the present exemplary embodiment, a distance that the display range can be moved with one drag operation assumed to be from the range 411 to the range 412 illustrated in FIG. 4.

Thus, there is a limit for an amount of the display range which can be moved with one operation. Therefore, for example, if the user wants to display the pins 304 and 305 corresponding to the image files 3 and 4 of the management table, respectively, if the screen illustrated in FIG. 3A is displayed, the user needs to repetitively perform an operation for moving the display range in the direction 413 which is troublesome.

In the present exemplary embodiment, if a predetermined condition is satisfied upon acceptance of a drag operation, the control unit 101 automatically keeps scrolling the map in a direction corresponding to the drag direction until a pin appears. In other words, by continuously passing through a range where a pin does not displayed without stopping at thereof, following the contact point, the control unit 101 automatically keeps moving the display range up to a range where a pin is displayed.

The predetermined condition is, for example, a flick operation. This predetermined condition is an example of a first condition. The user can input an instruction for performing automatic scrolling, for example, by performing a flick operation. This eliminates the need of repetitively performing the operation for moving the display range, for example, from the range 411 to the range 414. In the following descriptions, the above-described automatic scrolling is referred to as auto-scroll.

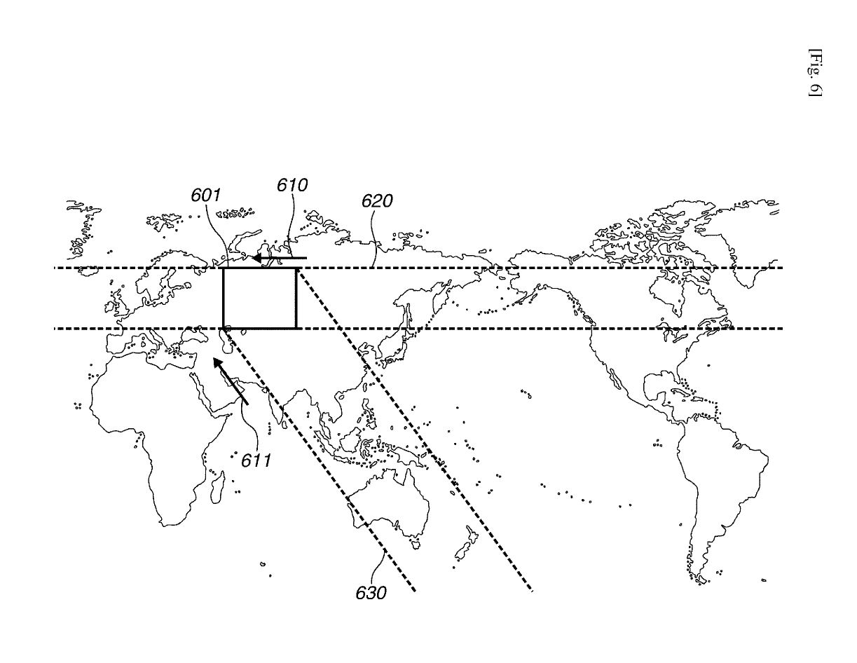

The following describes an operation performed by the information processing apparatus 100 when the information management application displays the map image. FIG. 5 is a flowchart illustrating an operation of the information processing apparatus 100 for displaying the map. The processing illustrated in this flowchart is started, for example, if the user selects a menu and an instruction for displaying the map display screen is received, and then implemented by the control unit 101 controlling each unit of the information processing apparatus 100 according to the OS and the information management application. This also applies to the subsequent flowcharts.

In step S501, the control unit 101 reads a map image of a predetermined scale from the storage medium 110, and displays thereof in the display area of the information management application window. At the same time, the control unit 101 further reads an image file, and arranges to display in the display area a pin indicating the imaging location of the image file based on the location information thereof. As a result of the processing in step S501, for example, a screen as illustrated in FIG. 3A is displayed.

In step S502, the control unit 101 determines whether an instruction for a user operation received via the operation unit 105 is received. The user can input an instruction for moving the display range via the operation unit 105. In the present exemplary embodiment, a description is made for an example in which the user inputs an instruction by using the touch panel of the operation unit 105.

In this case, the control unit 101 determines whether a user touch operation is received via the touch panel of the operation unit 105. For example, the user can input an instruction for moving the display range of the map by performing a drag operation. Further, the user can select an END button 330 by performing a touch-up operation in the display area of the END button 330. Thus, the user can input an instruction for ending of processing of this flowchart.

If the control unit 101 determines that a touch operation is not received (NO in step S502), the control unit 101 repeats the processing in step S502. Otherwise, if the control unit 101 determines that a touch operation is received (YES in step S502), the processing proceeds to step S503.

In step S503, the control unit 101 determines whether the received touch operation is a drag operation. Specifically, the control unit 101 stores in the memory 103 the starting position of the touch operation (i.e., touch-down position). Then, the control unit 101 compares the starting position of the touch operation (i.e., touch-down position) with the latest contact point position detected at intervals of unit time to determine whether the distance between contact points is equal to or larger than the predetermined distance. Specifically, the control unit 101 determines whether the finger has moved equal to or longer than the predetermined distance from the starting position of the touch operation to determine whether the received touch operation is a drag operation.

First of all, the following describes a case where the control unit 101 determines that the received touch operation is not a drag operation (NO in step S503). In this case, the processing proceeds to step S504.

In step S504, the control unit 101 determines whether a touch operation is performed, specifically, it detects whether a touch-up operation is performed. If the control unit 101 determines that a touch-up operation is not performed (NO in step S504), the processing returns to step S503.

This flow of processing applies to a case, for example, where the finger remains at the touch-down position without moving the contact point. Otherwise, if the control unit 101 determines that a touch-up operation is performed (YES in step S504), the processing proceeds to step S505. This flow of processing applies to a case, for example, where the user performs a touch-up operation at the touch-down position without moving the contact point.

In step S505, the control unit 101 determines whether the END button is selected, specifically, the control unit 101 determines whether the END button is selected by determining whether the position touched up is the position of the END button. When the control unit 101 determines that the END button is selected (YES in step S505), the processing ends the processing of this flowchart. Otherwise, if the control unit 101 determines that the END button is not selected (NO in step S505), the processing returns to step S502.

Processing performed if the control unit 101 determines that the received touch operation is not a drag operation in step S503 has specifically been described above.

Then, the following describes a case where the control unit 101 determines that the received touch operation is a drag operation (YES in step S503). In this case, the processing proceeds to step S506.

In step S506, the control unit 101 reads a map image corresponding to the contact point of the drag operation from the storage medium 110 and then displays thereof. At the same time, if the imaging location of an image file is included in the display range corresponding to the contact point of the drag operation, the control unit 101 arranges at the relevant position a pin indicating the imaging location of the image file. Thus, the control unit 101 performs control to update the map image to scroll the map, following the movement of the contact point.

The control unit 101 repeats the processing in step S506 until the control unit 101 determines in step S507 that a touch-up operation is detected, i.e., the drag operation is completed. Specifically, once the drag operation is received, the control unit 101 scrolls the map each time the movement of the contact point is detected, following the contact point, and repeats this processing until the user performs a touch-up operation.

In step S507, the control unit 101 determines whether the drag operation is completed, specifically, determination is made by detecting whether a touch-up operation is performed. If the control unit 101 determines that the drag operation is not completed (NO in step S507), the control unit 101 repeats the processing in steps S506 and S507. Otherwise, if the control unit 101 determines that the drag operation is completed (YES in step S507), the processing proceeds to step S508.

In step S508, the control unit 101 determines whether the received drag operation satisfies a predetermined condition. In the present exemplary embodiment, the predetermined condition is a “flick operation”. In this case, if a touch-up operation is detected after the drag operation, the control unit 101 acquires the magnitude of a moving vector of the coordinate of the contact point per unit time immediately before the touch-up operation.

In this case, the control unit 101 store in the memory 103 a plurality of recently detected coordinates out of the coordinates of contact points on the touch panel detected at intervals of unit time. The moving vector is calculated based on the plurality of the coordinates. In the present exemplary embodiment, the control unit 101 obtains the moving vector based on the coordinates of the latest two points after the timing of the touch-up operation. The magnitude of the moving vector indicates the moving speed of the contact point immediately before the touch-up operation. The control unit 101 determines whether the magnitude of the moving vector is equal to or larger than a predetermined value to determine whether the move operation is performed at speed equal to or faster than predetermined speed. Specifically, if the magnitude of the moving vector of the contact point immediately before the touch-up operation is equal to or larger than the predetermined value, i.e., the move operation immediately before the touch-up operation is performed at a speed equal to or faster than the predetermined speed, the control unit 101 determines that a flick operation is performed.

The reason why a flick operation is used as the predetermined condition will be described below. Quickly performing a move operation and a touch-up operation (i.e., performing a flick operation) to move the display range in a direction where a target image exists is assumed to be a more intuitive operation for the user. By distinguishing between the flick and drag operations in this way, the user can easily use an instruction for performing regular scroll and an instruction for performing auto-scroll for different purposes. For this reason, the control unit 101 uses the flick operation as the predetermined condition.

If the control unit 101 determines that the received touch operation is not a flick operation (NO in step S508), the processing returns to step S502, leaving the display range upon completion of the drag operation displayed.

Otherwise, if the control unit 101 determines that the received touch operation is a flick operation (YES in step S508), the control unit 101 determines that an instruction for performing auto-scroll is received, and the processing proceeds to step S509.

In step S509, the control unit 101 determines as a search range a range extending in a direction opposite to the direction of the received flick operation and having the width of the display range. The direction of the flick operation (hereinafter referred to flick direction) is obtained by detecting the direction of the moving vector of the contact point immediately before the touch-up operation.

In step S510, the control unit 101 determines whether there exists an imaging location of an image file is included in the search range.

The following describes the processing in steps S509 and S510 with reference to specific examples by using FIGS. 3A, 3B, 3C and 4. For example, a case where a flick operation is performed in the upward direction on the screen illustrated in FIG. 3A will be considered below.

In this case, the map image is scrolled in the upward direction. The search range is determined to be a range (range 420) extending in the downward direction and having the width of the display area corresponding to the relevant direction. Then, the control unit 101 determines whether there exists an image file whose imaging location is included in the search range. In this case, the control unit 101 determines the existence of an image file by referring to imaging locations of image files managed by the management table.

Referring to the example illustrated in FIG. 2, none of the imaging locations of the image files 1 to 4 is included in the range 420. In such a case, in step S510, the control unit 101 determines that there is no image file whose imaging location is included in the search range.

For example, if a flick operation is performed in a direction 413 illustrated in FIG. 4 on the screen illustrated in FIG. 3A, the map image is scrolled in the direction 413. The search range is determined to be a range (range 430) extending in a direction opposite to the direction 413 and having the width of the display range corresponding to the relevant direction. The control unit 101 determines whether there exists an image file whose imaging location is included in the search range. The imaging locations of the image files 3 and 4 are included in the range 430. Therefore, in this case, the control unit 101 determines that there exists an image file whose imaging location is included in the search range.

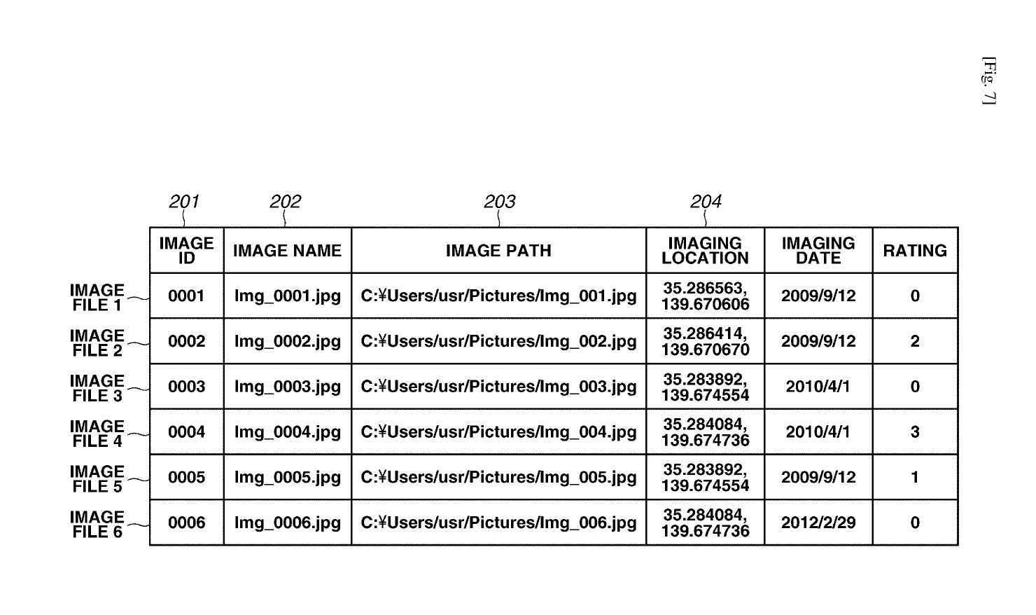

Although the search range is illustrated in FIG. 4 for description, the search range is actually determined over the entire range of the map stored in the storage medium 110. Further, if the map data is configured to loop in the east-west direction, as with the global map illustrated in FIG. 6, the search range may be determined on a loop basis.

For example, if the user performs a drag operation in a direction 610 on the screen displaying the display range equivalent to a range 601 illustrated in FIG. 6, the search range is extended to a range 620 which includes not only the east side of the range 601 but also the west side (loop-back side) thereof. In a case where the user performs an operation in a non-loop direction, for example, if the user performs a drag operation in a direction 611 on the screen displaying the display range equivalent to the range 601, a range 630 is determined to be the search range and a range on the opposite side is not the search range.

The search range determined by the processing in step S509 is based on the flick direction, the coordinates (latitude and longitude) of the four corners of the display range upon reception of a flick operation, and the coordinates of the entire map. In the present exemplary embodiment, the width of the search range is determined based on two diagonal points corresponding to the flick direction, out of the coordinates of the four corners of the display range rectangle upon reception of a flick operation. In this case, the two diagonal points are selected so as to obtain a wider search range.

If the control unit 101 determines that there is no image file whose imaging location is included in the search range (NO in step S510), the processing returns to step S502. Specifically, if there is no image in the direction corresponding to the flick direction, auto-scroll is not performed even if a flick operation is performed.

For example, even if the user performs a flick operation in the upward direction on the screen illustrated in FIG. 3A, auto-scroll is not performed because the imaging location of an image file is not included in the determined search range (range 430). In this case, the control unit 101 may notify the user of the fact that there is no file in a direction corresponding to the flick operation. For example, the notification may be made by displaying an error icon or displaying such a message as “NO FILE EXISTS IN THE SPECIFIED DIRECTION” for a predetermined period of time.

Otherwise, if the control unit 101 determines that there exists an image file whose imaging location is included in the search range (YES in step S510), the processing proceeds to step S511.

In step S511, the control unit 101 performs auto-scroll. Specifically, the control unit 101 automatically moves the display area while sequentially reading and displaying map images along the flick direction. In the auto-scroll operation, the control unit 101 keeps moving the display range until a pin indicating the imaging location closest to the display range upon reception of the instruction, out of the imaging locations in the search range, is displayed in the display area.

For example, if a flick operation is performed in a direction 413 on the screen illustrated in FIG. 3A, auto-scroll is performed until a pin is displayed in the display area. As a result, as illustrated in FIG. 3C, for example, if a range equivalent to the range 414 illustrated in FIG. 4 is displayed in the display area 301, auto-scroll stops.

The scrolling speed for auto-scroll is changed according to the magnitude of the moving vector of the contact point per unit time immediately before the touch-up operation. Specifically, performing a flick operation faster moves the display range at higher scrolling speed. As described in the description of the operation unit 105 illustrated in FIG. 1, a flick operation is detected if the user draws a stroke more quickly than the drag operation.

Specifically, the magnitude of the moving vector of the contact point per unit time immediately before a touch-up in a flick operation is larger than at least the magnitude of the moving vector of the contact point per unit time in a drag operation. Therefore, if the display range moves in a same distance, the display range moves faster in a flick operation than in a drag operation.

Further, auto-scroll enables automatically scrolling the map with only one operation without repeatedly performing the operation, reducing time of repeating an operation. This means that using auto-scroll enables displaying a range equivalent to the range 414 faster than repeating a drag operation. Then, the processing returns to step S502.

The operation performed by the information processing apparatus 100 when the information management application displays the map image has specifically been described above. As described above, if the imaging location of an image file exists in the direction corresponding to a user operation, the information processing apparatus 100 according to the present exemplary embodiment performs map image auto-scroll until the imaging location of the image file is included in the display range.

Thus, the user only needs to perform a flick operation only once, and does not need to repetitively performing an operation for scrolling the map image until the imaging location of the image file is included in the display range. Since auto-scroll stops if an imaging location of an image file is included in the display range, the user does not need to check whether a pin indicating the shooting location of an image file is displayed in a range newly displayed in response to a scroll instruction. This reduces the process of user operations for searching for a target image, shortening the time until the target image is displayed.

A second exemplary embodiment will be described below. In the first exemplary embodiment, regardless of the type of an image in the search range, auto-scroll is stopped if a pin indicating the imaging location of the image is displayed in the display range. Specifically, all of image files are subjected to search with auto-scroll.

On the other hand, in the second exemplary embodiment, only image files satisfying a user-preset condition are subjected to search. In descriptions of the present exemplary embodiment, a condition used by the control unit 101 to determine whether an image is subjected to search will be referred to as a search condition. The search condition is an example of a second condition. The present and first exemplary embodiments have many duplicated elements, descriptions will be made centering on elements specific to the present exemplary embodiment, and redundant description thereof will be omitted.

FIG. 7 schematically illustrates a management table according to the present exemplary embodiment. An image management application manages attribute information for each image file. For example, as illustrated in FIG. 7, the image management application manages a rating value, imaging date, shooting location, etc. for each image file by using the management table.

Elements having the same function as those in FIG. 2 are assigned the same reference numeral. The schematic view of this management table is to be considered as an example, and the management table may include other pieces of information in addition to the ones illustrated in FIG. 7. Further, the attribute information of image files is not limited to the rating value, imaging date, and imaging location.

The attribute information records other various information, such as information indicating the model of an imaging apparatus used for imaging, the weather at the time of imaging, the white balance at the time of imaging, and the diaphragm value at the time of imaging. Image files 1 to 6 are stored in the management table illustrated in FIG. 7. Of these, the image files 1 to 4 are the same as those in the first exemplary embodiment. The image files 5 and 6 are newly appended to the management table.

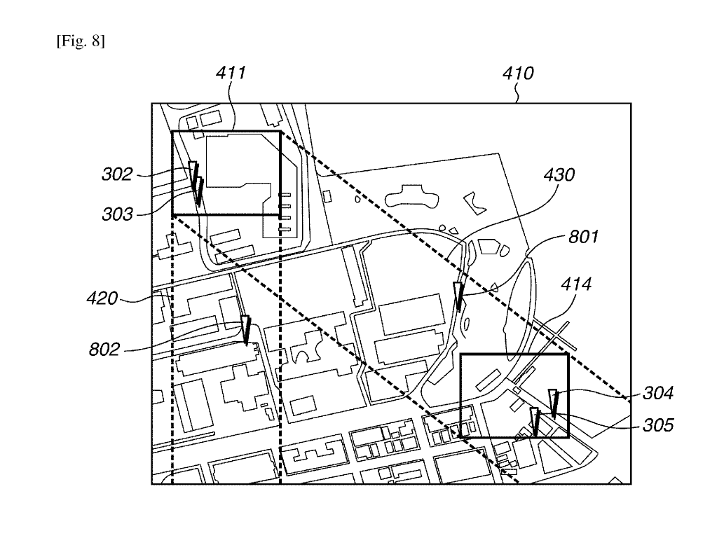

Relationships between the imaging locations of the image files 1 to 6 are illustrated in FIG. 8. Referring to FIG. 8, elements having the same function as those in FIG. 4 are assigned the same reference numeral. Similar to FIG. 4, the imaging locations of the image files 1 to 4 are indicated by pins 302, 303, 304, and 305, respectively. The imaging location of the image file 5 is indicated by a pin 801. The imaging location of the image file 6 is indicated by a pin 802. Suppose that a flick operation is received if a range equivalent to the range 411 illustrated in FIG. 8 is displayed as the display range, and the range 430 is determined as the search range. The imaging locations of the image files 3 to 5 are included in this search range.

If a condition “IMAGE WITH RATING EQUAL TO OR HIGHER THAN 3” is set as an image file search condition, the image file 5 is not subjected to search. Therefore, auto-scroll does not stop even if a pin indicating the imaging location of the image file 5 is displayed in the display area, and the control unit 101 keeps moving the display range until the screen displays the display range equivalent to the range 414.

Further, for example, if the range 420 is determined as the search range and the search condition is “IMAGE WITH RATING EQUAL TO OR HIGHER THAN 3”, the control unit 101 performs similar processing to the case where a drag operation is received. This is because the image file 6 corresponding to the pin 802 has rating 0, and the condition “IMAGE WITH RATING EQUAL TO OR HIGHER THAN 3” is not satisfied.

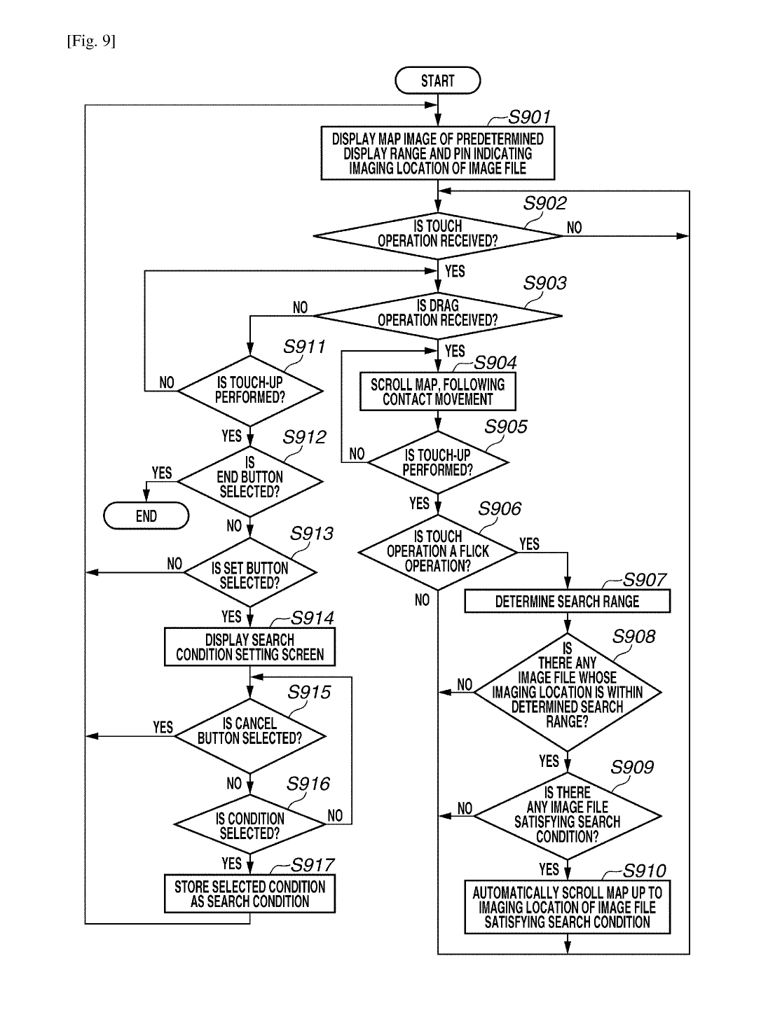

FIG. 9 is a flowchart illustrating an operation performed by the information processing apparatus 100 to achieve the above-described operation. The flowcharts in FIGS. 5 and 9 have many duplicated steps, descriptions will be made centering on elements specific to the present exemplary embodiment, and redundant description thereof will be omitted.

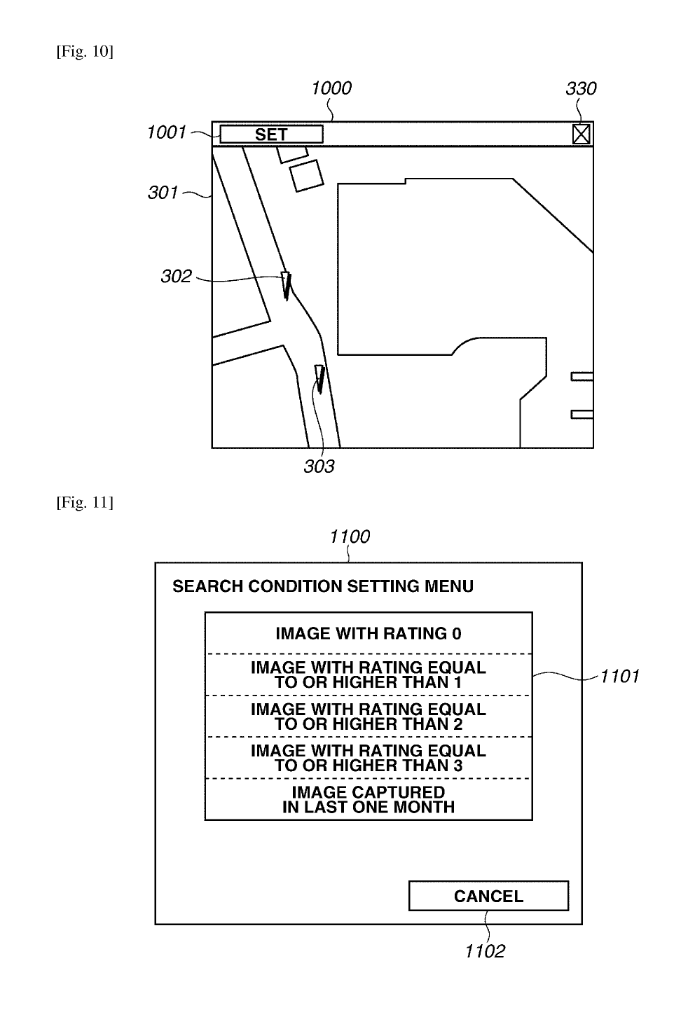

In step S901, the control unit 101 performs similar processing to step S501. For example, the control unit 101 displays a screen 1000 as illustrated in FIG. 10. Referring to FIG. 10, elements having the same function as those in FIG. 3A are assigned the same reference numeral.

In step S902, the control unit 101 determines whether an operation is received from the user via the operation unit 105. The user can input an instruction for moving the display range via the operation unit 105.

For example, the user can input an instruction for moving the display range of the map by performing a drag operation. Further, the user can select a SET button 1001 by performing a touch-up operation in the display area of the SET button 1001. The SET button 1001 is used to set a condition of images at which scrolling is stopped at the time of auto-scroll. In other words, this button is used to set a condition of images subjected to search.

The user can input an instruction for displaying a setting menu for setting the condition of images subjected to search by selecting the SET button 1001. Further, the user can select the END button 330 by performing a touch-up operation in the display area of the END button 330. Thus, the user can input an instruction for ending the process of this flowchart.

If the control unit 101 determines that a touch operation is not received (NO in step S902), the processing returns to step S902. Otherwise, if the control unit 101 determines that a touch operation is received (YES in step S902), the processing proceeds to step S903.

In step S903, similar to step S503 illustrated in FIG. 5, the control unit 101 determines whether the received touch operation is a drag operation.

First of all, the following describes a case where the control unit 101 determines that the received touch operation is not a drag operation (NO in step S903). In this case, the processing proceeds to step S911.

In step S911, similar to step S504 illustrated in FIG. 5, the control unit 101 determines whether a touch operation is performed, specifically, it determines whether a touch operation is performed by detecting whether a touch-up operation is performed. If the control unit 101 determines that a touch-up operation is not performed (NO in step S911), the processing returns to step S903. Otherwise, if the control unit 101 determines that a touch-up operation is performed (YES in step S911), the processing proceeds to step S912.

In step S912, the control unit 101 determines whether the END button is selected, specifically, it determines whether the END button is selected by determining whether the touch-up position is the position of the END button. If the control unit 101 determines that the END button is selected (YES in step S912), the processing ends the process of this flowchart. Otherwise, if the control unit 101 determines that the END button is not selected (NO in step S912), the processing proceeds to step S913.

In step S913, the control unit 101 determines whether the SET button is selected, specifically, it determines whether the SET button is selected by determining whether the touch-up position is the position of the SET button. If the control unit 101 determines that the SET button is not selected (NO in step S913), the processing returns to step S901. Otherwise, if the control unit 101 determines that the SET button is selected (YES in step S913), the processing proceeds to step S914.

In step S914, the control unit 101 displays a screen 1100 illustrated in FIG. 11 and receives a user instruction. FIG. 11 illustrates an example of a screen for setting a condition of images subjected to search. By touching down on a condition item display area in the selection frame 1101, the user can set the relevant condition as a search condition. As illustrated in the selection frame 1101, the settable search condition is not limited to the rating of image files.

For example, selecting the condition “IMAGE CAPTURED IN LAST ONE MONTH” in the selection frame 1101 illustrated in FIG. 11 enables setting a condition used in searching for image files captured in the last one month. Further, performing a drag or flick operation in the vertical direction within the selection frame 1101 enables scrolling condition items therein to make hidden condition items visible. Further, by touching down on the display area of the CANCEL button 1102, the user can select the CANCEL button 1102. Thus, the user can end display of the setting menu and input an instruction for returning to the screen 1000 illustrated in FIG. 10.

In step S915, the control unit 101 determines whether the CANCEL button 1102 is selected. If the control unit 101 determines that the CANCEL button 1102 is selected (YES in step S915), the processing returns to step S901. Otherwise, if the control unit 101 determines that the CANCEL button 1102 is not selected (NO in step S915), the processing proceeds to step S916.

In step S916, the control unit 101 determines whether a condition is selected. If the control unit 101 determines that a condition is not selected (NO in step S916), the processing returns to step S915. Otherwise, if the control unit 101 determines that a condition is selected (YES in step S916), the processing proceeds to step S917.

In step S917, the control unit 101 retains the selected condition in the nonvolatile memory 104 as a search condition. Then, the processing returns to step S901.

Processing for receiving a setting instruction if the control unit 101 determines in step S903 that the received touch operation is not a drag operation has specifically been described above.

Then, the following describes a case where the control unit 101 determines that the received touch operation is a drag operation (YES in step S903). In this case, the processing proceeds to step S904. Processing in steps S904 to S908 is similar to processing in steps S506 to S510 illustrated in FIG. 5, and redundant description thereof will be omitted. Similar to step S508, if the processing returns from step S906 to step S902, the display range upon completion of the last drag operation remains displayed.

In step S909, the control unit 101 determines whether there exists an image file satisfying the search condition out of image files whose imaging locations are determined to be included in the display range in step S908. The search condition used in this case is the search condition stored in the nonvolatile memory 104 in step S917.

The following describes an example of a case where the search condition “IMAGE WITH RATING EQUAL TO OR HIGHER THAN 3” is preliminary set in the processing in steps S914 to S917 before the processing in step S909 is executed.

In this case, the control unit 101 searches for image files with rating equal to or higher than 3 out of image files whose imaging locations are determined to be included in the display range in step S908. When performing a search, the control unit 101 refers to the rating stored in the management table.

In the example according to the present exemplary embodiment, only the image file 4 has rating equal to or higher than 3. For example, if the search range determined in step S907 is the range 420 illustrated in FIG. 8, the imaging location of the image file 6 is included in the search range. However, the image file 6 has rating 0 and therefore does not satisfy the condition “IMAGE WITH RATING EQUAL TO OR HIGHER THAN 3”. Therefore, in this case, the control unit 101 determines that there is no image file satisfying the search condition, and processing returns to step S902.

If there is no image file satisfying the search condition in the direction corresponding to a user operation, the control unit 101 performs similar processing to the case where a drag operation is determined to be received. Further, for example, if the search range is the range 430 illustrated in FIG. 8, the shooting location of the image file 4 is included in the search range. In this case, in step S909, the control unit 101 determines that there exists an image file satisfying the search condition, and the processing proceeds to step S910.

In step S910, the control unit 101 scrolls the display range until the shooting location of an image file closest to the current display range, out of image files satisfying the search condition, is included in the display range. Referring to the example illustrated in FIG. 8, the control unit 101 does not stop scrolling in the display range displaying the pin indicating the imaging location of the image file 5 but scrolls the map up to the display range equivalent to the range 414, and then stops scrolling. Upon completion of the processing in step S909, the processing returns to step S902.

Processing for receiving an instruction for changing the display range if the control unit 101 determines in step S903 that the received touch operation is a drag operation has specifically been described above.

Operations performed by the information processing apparatus according to the present exemplary embodiment have specifically been described above.

The present exemplary embodiment is described to enable setting a condition used in searching for images by auto-scroll. Thus, it is possible to quickly display an image according to user's preferences, providing a comfortable operational feeling.

A third exemplary embodiment will be described below. The first and second exemplary embodiments are described to use a flick operation as the predetermined condition used for determining whether an auto-scroll instruction is received. On the other hand, in the present exemplary embodiment, the user can arbitrarily set conditions other than the flick operation.

In the description of the present exemplary embodiment, a predetermined condition used by the control unit 101 to determine whether an auto-scroll instruction is received is referred to as a start condition. The present and first exemplary embodiments have many duplicated elements, descriptions will be made centering on elements specific to the present exemplary embodiment, and redundant description thereof will be omitted.

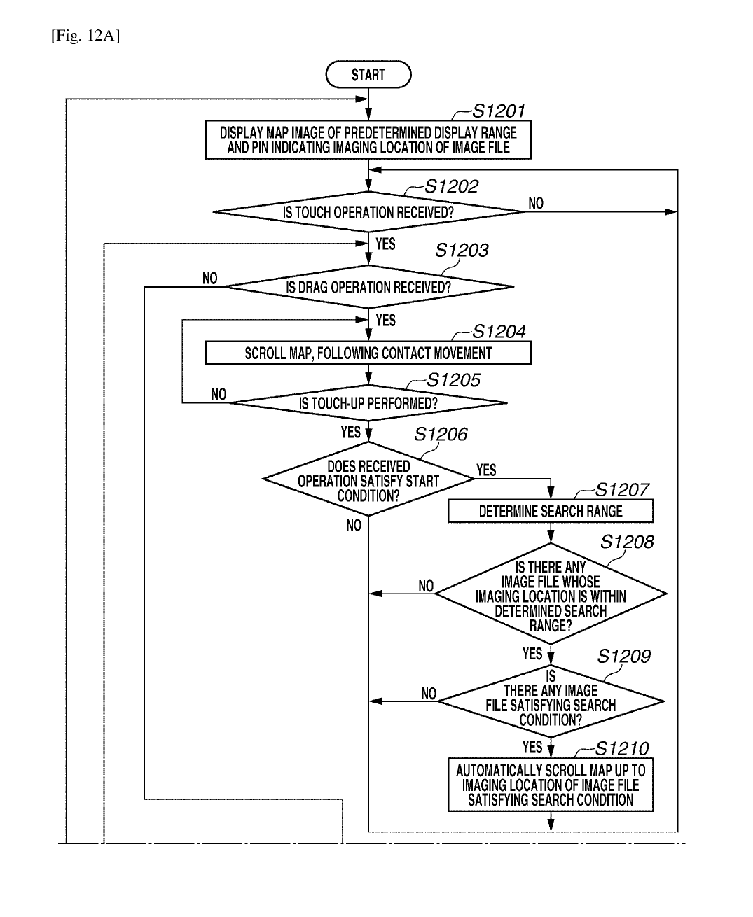

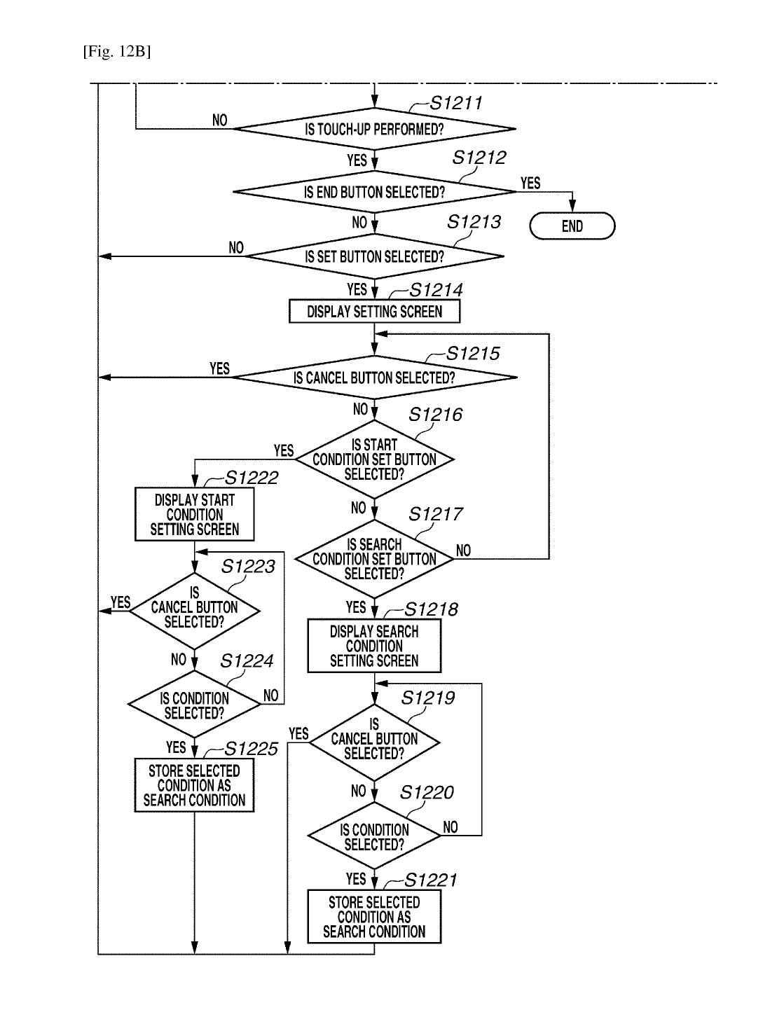

FIG. 12, which is composed of FIGS. 12A and 12B, is a flowchart illustrating an operation of the information processing apparatus according to the present exemplary embodiment.

In steps S1201 to S1213, the control unit 101 performs similar processing to steps S901 to S913 illustrated in FIG. 9. In step S1201, the screen 1000 as illustrated in FIG. 10 is displayed similar to step S901 illustrated in FIG. 9. In step S1202, similar to step S902 illustrated in FIG. 9, the control unit 101 receives an instruction for displaying a setting menu by selecting the SET button.

If the control unit 101 determines that the SET button is selected (YES in step S1213), the processing proceeds to step S1214.

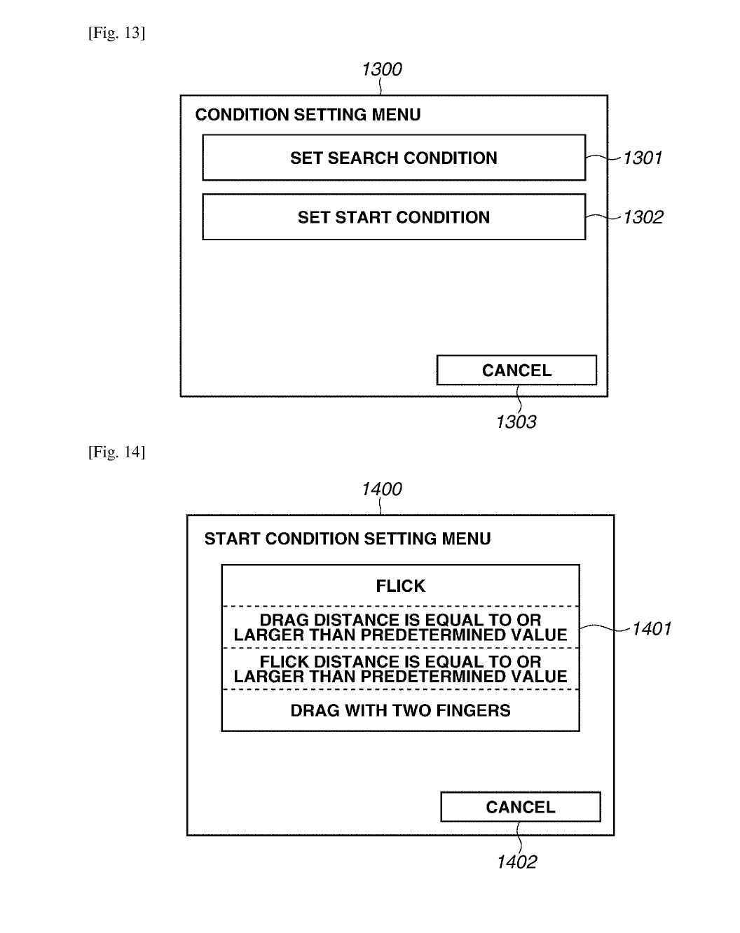

In step S1214, the control unit 101 displays a screen 1300 illustrated in FIG. 13 and receives a user instruction. FIG. 13 illustrates a screen for selecting execution of either the processing for setting a search condition described in the second exemplary embodiment or the processing for setting a start condition. By selecting each button via the operation unit 105, the user can input an instruction corresponding to the selected button.

For example, by selecting a set search condition button 1301 displayed on the screen, the user can input an instruction for performing processing for setting a search condition. Further, by selecting the set start condition button 1302 displayed on the screen, the user can input an instruction for performing processing for setting a start condition. Further, by selecting the cancel button 1303, the user can input an instruction for returning to display of the screen 1000 illustrated in FIG. 10.

In step S1215, the control unit 101 determines whether the cancel button is selected. If the control unit 101 determines that the cancel button 1303 is selected (YES in step S1215), the processing returns to step S1201. Otherwise, if the control unit 101 determines that the cancel button 1303 is not selected (NO in step S1215), the processing proceeds to step S1216.

In step S1216, the control unit 101 determines whether the set start condition button 1302 is selected.

First of all, the following describes a case where the control unit 101 determines that the set start condition button 1301 is not selected (NO in step S216). In this case, the processing proceeds to step S1217.

In step S1217, the control unit 101 determines whether the set search condition button 1302 is selected. If the control unit 101 determines that the set search condition button 1302 is not selected (NO in step S1217), the processing returns to step S1215. Otherwise, if the control unit 101 determines that the set search condition button 1302 is selected (YES in step S1217), the processing proceeds to step S1218.

In step S1218 to S1221, the control unit 101 performs similar processing to steps S914 to 917 illustrated in FIG. 9, and redundant description thereof will be omitted.

Then, the following describes a case where the control unit 101 determines that the set start condition button 1301 is selected (YES in step S1216). In this case, the processing proceeds to step S1222. In step S1222, the control unit 101 displays a screen 1400 illustrated in FIG. 14 and receives a user instruction.

FIG. 14 illustrates an example of a screen for setting a start condition. By touching down on a display area of condition item in the selection frame 1401, the user can set the relevant condition as a start condition. As illustrated in the selection frame 1401, not only “FLICK” but also various conditions can be set. For example, selecting “DRAG DISTANCE IS EQUALS TO OR LARGER THAN PREDETERMINED VALUE” enables setting a condition for starting auto-scroll if the distance between the touch-down and touch-up positions of a drag operation is equal to or larger than a predetermined value regardless of the speed of the drag operation.

Further, for example, selecting “DRAG WITH TWO FINGERS” as a start condition enables setting a condition for starting auto-scroll if similar drag operations are performed at two different contact points regardless of the distance and speed of the drag operations. In the present exemplary embodiment, each condition item is related to an operation for changing the display range, emphasizing more intuitive operational feeling for the user.

Further, performing a drag or flick operation in the vertical direction within the selection frame 1401 enables scrolling condition items therein to make hidden condition items visible. By touching down on the display area of the cancel button 1402, the user can select the cancel button 1402. In this case, the user can input an instruction for ending display of the screen 1400 and returning to display of the screen 1000 illustrated in FIG. 10.

In step S1223, the control unit 101 determines whether the cancel button 1402 is selected. If the control unit 101 determines that the cancel button 1402 is selected (YES in step S1223), the processing returns to step S1201. Otherwise, if the control unit 101 determines that the cancel button 1402 is not selected (NO in step S1223), the processing proceeds to step S1224.

In step S1224, the control unit 101 determines whether a condition is selected. If the control unit 101 determines that a condition is not selected (NO in step S1224), the processing returns to step S1223. Otherwise, if the control unit 101 determines that a condition is selected (YES in step S1224), the processing proceeds to step S1225.

In step S1225, the control unit 101 retains the selected condition in the nonvolatile memory 104 as a start condition. Then, the processing returns to step S1201. The stored start condition will be used in step S1206.

The information processing apparatus according to the present exemplary embodiment has specifically been described above. The information processing apparatus according to the present exemplary embodiment enables the user to arbitrarily set a condition used in determining whether auto-scroll is performed, thus providing operational feeling according to user's preferences.

Other exemplary embodiments will be described below. In the above-described exemplary embodiments, the operation for scrolling the map image is not limited to touch panel operations. For example, an icon for scrolling the map image, such as a directional button, may be displayed and selected by using the mouse. In this case, the predetermined condition (start condition) is set as “the icon is kept being selected for a predetermined period of time” or “the icon is selected a plurality of number of times within a predetermined period of time”.

Further, even if the touch panel is used, this icon may be displayed and made selectable. Alternatively, a hardware key enabling direction selection, such an arrow key. In such a case, the predetermined condition (start condition) is set as “an arrow key is kept being pressed for a predetermined period of time” or “an arrow key is pressed a plurality of number of times within a predetermined period of time”. These operation methods may be used in combination.

In addition to the above-described exemplary embodiments, when performing auto-scroll, the map image may be scrolled so that the imaging location closest to the current display range may be displayed at the center of the display range. Further, the action when auto-scroll is stopped may be preset by the user.

In addition to the above-described exemplary embodiments, a plurality of sets of start and search conditions may be stored. With this configuration, suppose a case where a set of start condition “FLICK” and search condition “ALL IMAGES”, and a set of start condition “FLICK WITH TWO FINGERS” and search condition “IMAGE WITH RATING 0” are stored.

In this case, all images are subjected to auto-scroll if the operation received from the user is a flick operation, or images with rating 0 are subjected to auto-scroll if the received operation is a two-finger flick operation. These sets can be set through menu operation by the user. Thus, storing start and search conditions in an associated way enables displaying a desired range of the map with easy operations, resulting in improved usability.

In the above-described exemplary embodiments, the auto-scroll processing is performed after completion of the processing in steps S509 and S510 illustrated in FIG. 5 and the processing in steps S907 to S909 illustrated in FIG. 9. If a flick operation is determined in step S508 illustrated in FIG. 5 and step S906 illustrated in FIG. 9, the control unit 101 may start moving the display range in parallel with the processing in subsequent steps S509 and S907.

The reason why the above-described processing will be described below. If the processing in steps S509 to S510 illustrated in FIG. 5 and the processing in steps S907 to S909 illustrated in FIG. 9 take time, the display range which once stopped after a flick operation automatically starts moving, possibly giving the user a sense of discomfort. Therefore, in parallel with the processing in steps S509 and S510 illustrated in FIG. 5 and the processing in steps S907 to S909 illustrated in FIG. 9, the control unit 101 starts moving the display range in the auto-scroll processing. If the control unit 101 determines that there is no image subjected to search, the control unit 101 enters the inertia-scroll operation mode. Inertia scrolling refers to an operation in which the display range moves in a sliding way over a constant distance at gradually reduced moving speed even after the finger is detached from the touch panel.

Otherwise, if the control unit 101 determines that there exists an image subjected to search, the control unit 101 continues moving the display range in the auto-scroll processing. Controlling the movement of the display range in this way enables seamlessly connecting the movement of the display range during a drag operation and the movement of the display range during a flick operation, reducing the possibility of giving the user a sense of discomfort.

However, with the above-described processing, there may exist an image in a range in which the display range is movable before completion of search. For this reason, while the map image is displayed, the control unit 101 may preliminary load information of images existing not only in the current display range but also images in ranges around the current display range. Then, upon reception of an auto-scroll instruction due to a flick operation, the control unit 101 may refer to the positions of preliminary loaded images and, if there exists an image in a range in which the display range is movable before completion of search, stop moving the display range without waiting for the result of search.

Alternatively, the control unit 101 may determine the search range within a range in which a processing speed not giving the user a sense of discomfort can be maintained, and searches for an image in the relevant range. In particular, if the user wants to include an image at a separate point in the moving direction of the display range, it is expected that the user performs a flick operation repetitively, at a high flick speed, or over a long flick distance to reach the relevant display range as soon as possible. In this case, the above-described processing can reduce the possibility of excessive movement of the display range.

The above-described exemplary embodiments are described to store map images and image files in the storage medium 110. Map images may be downloaded from a server at any timing. Further, image files may also be obtained by downloading thereof by accessing on an as-needed basis a server at timing when accessing is necessary.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-107877, filed May 9, 2012, which is hereby incorporated by reference herein in its entirety.

1. An information processing apparatus capable of displaying in a display area a partial range of a map image as a display range, the information processing apparatus comprising:
an object display unit configured to display an object associated with location information at a location based on the location information on the map image in the display area;
an operation unit configured to receive an instruction corresponding to a user operation; and
a display control unit configured to move, if an instruction for moving the display range of the map image is received by the operation unit, the map image to an instructed direction to display thereof,
wherein the instruction for moving the display range of the map image includes directional information,
wherein if the instruction for moving the display range of the map image received by the operation unit satisfies a first condition, the display control unit performs control to move the display range until an object not displayed in the display area during receiving the instruction is displayed, and then to stop moving the display range, and
wherein the first condition includes a condition according to a level of the instruction for moving the display range of the map image received by the operation unit.

2. The information processing apparatus according to claim 1, wherein if the instruction for moving the display range on the map image received by the operation unit does not satisfy the first condition, the display control unit performs control to move the display range up to a position corresponding to the instruction, and then stop moving the display range.

3. The information processing apparatus according to claim 1, further comprising a search unit configured to search for an object included in a search range determined based on the directional information included in the instruction for moving the display range of the map image received by the operation unit, and on a current display range,
wherein if the instruction for moving the display range on the map image received by the operation unit satisfies the first condition, the display control unit performs control to move the display range until the object searched for by the search unit is displayed, and then stop moving the display range.

4. The information processing apparatus according to claim 3, wherein, if there is no object in the search range, the display control unit performs control to move the display range up to a position corresponding to the instruction, and then stop moving the display range.

5. The information processing apparatus according to claim 1, further comprising a search unit configured to search for an object included in a search range determined based on the directional information included in the instruction for moving the display range of the map image received by the operation unit, and on a current display range,
wherein if the instruction for moving the display range on the map image received by the operation unit satisfies the first condition, the display control unit performs control to start moving the display range corresponding to the instruction, and then stop moving the display range at a position where the object searched for by the search unit is displayed.

6. The information processing apparatus according to claim 1, wherein if the instruction for moving the display range of the map image received by the operation unit satisfies the first condition, the display control unit performs control to move the display range until an object satisfying a second condition is displayed, and then stop moving the display range.

7. The information processing apparatus according to claim 6, further comprising an associating unit configured to associate the first and second conditions,
wherein if the instruction for moving the display range on the map image received by the operation unit satisfies the first condition, the display control unit performs control to move the display range until the object satisfying the second condition corresponding to the first condition is displayed, and then stop moving the display range.

8. The information processing apparatus according to claim 6, wherein the object is information on image data, and
wherein the second condition is set based on attribute information of the image data.

9. The information processing apparatus according to claim 6, wherein the object is information indicating image data, and
wherein the second condition is set based on at least one of information on rating of the image data and information on imaging date of the image.

10. The information processing apparatus according to claim 1, wherein the first condition is set based on the user operation.

11. The information processing apparatus according to claim 1, wherein the operation unit includes a touch panel, and
wherein the first condition includes at least one of a flick operation, a flick speed equal to or larger than a predetermined value, the number of flick operations per unit time equal to or larger than a predetermined value, and a flick distance equal to or larger than a predetermined value.

12. The information processing apparatus according to claim 1, further comprising:
an icon display control unit configured to perform control to display in the display area an icon for moving the display range; and
a reception unit configured to receive the instruction for moving the display range by receiving a selection of the icon,
wherein the first condition includes at least one of a state where the icon is selected for equal to or longer than a predetermined period of time and a state where the icon is selected a plurality of number of times within a predetermined period of time.

13. The information processing apparatus according to claim 1, further comprising an imaging unit configured to image an image of a subject and generating image data,
wherein the object is associated with the image data generated by the imaging unit.

14. The information processing apparatus according to claim 1, further comprising a storage unit configured to store image data conforming to the EXIF-JPEG standard,
wherein the object is associated with the image data stored by the storage unit.

15. The information processing apparatus according to claim 1, further comprising a storage unit configured to store image data,
wherein the location information associated with the object is stored in a header area of corresponding image data out of the image data stored by the storage unit.

16. The information processing apparatus according to claim 1, further comprising a communication unit configured to communicate with an external device,
wherein the map image is received from the external device via the communication unit.

17. The information processing apparatus according to claim 16, wherein the communication unit receives the map image through communication with the external device conforming to the Hypertext Transfer Protocol (HTTP).

18. A method for controlling an information processing apparatus capable of displaying in a display area a partial range of a map image as a display range, the method comprising:
displaying an object associated with location information at a location based on the location information on the map image in the display area;
receiving an instruction for moving the display range of the map image, the instruction including directional information;
performing, if the instruction for moving the display range of the map image satisfies a first condition, control to move the display range until an object not displayed in the display area during receiving the instruction is displayed, and then to stop moving the display range, and
wherein the first condition includes a condition according to a level of the received instruction for moving the display range of the map image.

19. A computer-readable nonvolatile recording medium storing a program for causing a computer to function as each unit of the information processing apparatus according to claim 1.

20. The information processing apparatus according to claim 1, wherein the level changes according to a level of the user operation.

21. The information processing apparatus according to claim 1, wherein the level includes at least one of a level according to a number of instructions and a level according to a time of an instruction.
